(19) United States
(12) Patent Application Publication
(10) Pub. No.: US 2022/0144043 A1
(43) Pub. Date: May 12, 2022

(54) HEATING DEVICE FOR VEHICLE AND VEHICLE

(71) Applicant: MITSUBISHI HEAVY INDUSTRIES THERMAL SYSTEMS, LTD., Tokyo (JP)

(72) Inventors: Noriyuki CHIKAGAWA, Tokyo (JP); Hideya NISHIJIMA, Tokyo (JP)

(73) Assignee: MITSUBISHI HEAVY INDUSTRIES THERMAL SYSTEMS, LTD., Tokyo (JP)

(21) Appl. No.: 17/602,181

(22) PCT Filed: Apr. 9, 2019
(86) PCT No.: PCT/JP2019/015383

§ 371 Date: Oct. 7, 2021

(51) Int. Cl. B60H 1/22; B60H 1/00

(52) U.S. Cl. CPC B60H 1/2225; B60H 1/00028; B60H 2001/00128; B60H 1/00807; B60H 1/2218

(57) ABSTRACT

The objective of the present invention is to decrease air temperature reduction along an indoor-side surface of a vehicle opening part caused by heat transfer from outside air. A heating device for a vehicle is provided with a heat generating part (2) which is installed on a vehicle component provided along an edge of a vehicle opening part, and which increases, via heat generation, the temperature of low temperature air along an indoor-side surface of the vehicle opening part caused by heat transfer from outside air. The heat generating part (2) may be disposed along an opening part installed with a vehicle window (52), and the heat generating part (2) may include an electric heater that uses electric power as a heat source.

### TECHNICAL FIELD

The present invention relates to a heating device for a vehicle and a vehicle.

### BACKGROUND ART

In a vehicle such as an automobile, heating, ventilation, and air conditioning (HVAC) is used to heat an interior. HVAC includes a heater, a blower (fan), a heat pump system including a refrigerant circuit, and the like.

PTL 1 discloses a technique relating to an air conditioning device for a vehicle that cools the periphery of the head of an occupant sitting in a seat while heating the body and the like of the occupant.

### CITATION LIST

### Patent Literature

[PTL 1] Japanese Unexamined Patent Application Publication No. 2018-131006

### SUMMARY OF INVENTION

### Technical Problem

Since electric power is used in HVAC, a large amount of electric power is required to heat air in the entire interior of a vehicle and to provide reliably the feeling of heating to the occupant, so that the electric power consumption increases, which is a problem. In a vehicle such as an automobile, since electric power that can be generated and used in the vehicle or electric power to be stored is limited, suppressing the electric power consumption is required. This problem occurs in any case of an automobile using an engine (internal combustion engine) as a driving source, an electric vehicle, and a hybrid vehicle.

In winter, particularly in cold regions, air along an interior side surface of a vehicle window such as a front window (windshield), a side window, and a rear window is cooled by heat transfer from outside air through the vehicle window. As a result, a phenomenon (cold draft) in which the cooled air (cold air) flows downward in the interior due to convection occurs. Therefore, even when the temperature inside the vehicle is increased to a set temperature by HVAC, the feeling of heating to be provided to the occupant is reduced due to the cold air, which is a problem.

The present invention has been made in view of such circumstances, and an object of the present invention is to provide a heating device for a vehicle capable of reducing a decrease in temperature of air generated along an interior side surface of a vehicle opening by heat transfer from outside air, and a vehicle.

### Solution to Problem

In order to solve the above problems, a heating device for a vehicle and a vehicle of the present invention adopt the following means.

Namely, according to an aspect of the present invention, there is provided a heating device for a vehicle including: a heating unit that is installed in a component of a vehicle provided along an edge of a vehicle opening, and that performs heating to increase a temperature of low-temperature air generated along an interior side surface of the vehicle opening by heat transfer from outside air.

According to this configuration, the heating unit is installed in the component of the vehicle provided along the edge of the vehicle opening, and the heating unit performs heating to increase the temperature of the low-temperature air generated along the interior side surface of the vehicle opening by heat transfer from the outside air. The vehicle opening is, for example, an opening in which a door for getting in and out or a door for loading of the vehicle is installed, or an opening in which a vehicle window such as a front window (windshield), a side window, or a rear window is installed.

In the invention, the vehicle opening may be an opening in which a vehicle window is installed, and the heating unit may be provided along the opening in which the vehicle window is installed.

According to this configuration, the heating unit is installed in the component of the vehicle provided along an edge of the opening in which the vehicle window is installed, and the heating unit performs heating to increase the temperature of low-temperature air generated along an interior side surface of the vehicle window by heat transfer from outside air. The heating unit is installed, for example, around the vehicle window, particularly along a lower side of the vehicle window.

In the invention, the heating unit may include an electric heater using electric power as a heat source.

According to this configuration, the temperature of the low-temperature air generated along the interior side surface of the vehicle opening is increased by heating of a heat generating body using electric power as a heat source.

In the invention, the heating unit may include a heat exchanger through which a heat medium of which a temperature is increased by heating flows.

According to this configuration, the temperature of the low-temperature air generated along the interior side surface of the vehicle opening is increased by heating of the heat exchanger through which the heat medium of which the temperature is increased by heating flows.

In the invention, the heating unit may be installed so as to face an interior of the vehicle.

According to this configuration, the heating unit is installed so as to face the interior of the vehicle, so that air on an interior side of the vehicle facing the heating unit is heated.

In the invention, the heating unit may be installed such that a high-temperature portion of which a temperature is increased by heating is not exposed to the interior of the vehicle.

According to this configuration, an occupant of the vehicle can be prevented from coming into contact with the heating unit and getting burned.

In the invention, an air flow path in which the heating unit is installed and through which air flows, and a blowing unit which causes the air to flow through the air flow path may be provided. The heating unit may be configured to heat the air flowing through the air flow path.

According to this configuration, the heating unit heats the air flowing through the air flow path, and the heated air is sent to the interior of the vehicle.

In the invention, the heating device for a vehicle may further include a control unit that controls heating of the heating unit based on a temperature detected by a temperature detection unit that is installed in the component of the vehicle to detect the temperature.

According to this configuration, the temperature detection unit installed in the component of the vehicle detects temperature, and heating of the heating unit is controlled based on the detected temperature. The temperature detection unit is, for example, an infrared (IR) sensor, a solar radiation sensor, or the like that is installed in the vehicle.

A vehicle according to an aspect of the present invention includes the above-described heating device for a vehicle.

According to this configuration, the above-described heating device for a vehicle is installed in the vehicle, and the heating unit of the heating device for a vehicle performs heating to increase the temperature of low-temperature air generated along an interior side surface of a vehicle opening by heat transfer from outside air.

### Advantageous Effects of Invention

According to the present invention, a decrease in temperature of the air generated along the interior side surface of the vehicle opening by heat transfer from the outside air can be reduced, and a phenomenon (cold draft) in which cold air flows downward in the interior due to convection can be suppressed.

### BRIEF DESCRIPTION OF DRAWINGS

FIG. 1 is a block diagram illustrating a heating device for a vehicle according to a first embodiment of the present invention.

FIG. 2 is a front view illustrating a vehicle door and a vehicle window provided in a vehicle.

FIG. 3 is a block diagram illustrating a heating device for a vehicle according to a second embodiment of the present invention.

FIG. 4 is a schematic perspective view illustrating the heating device for a vehicle according to the second embodiment of the present invention.

FIG. 5 is a block diagram illustrating a heating device for a vehicle according to a third embodiment of the present invention.

FIG. 6 is a schematic perspective view illustrating the heating device for a vehicle according to the third embodiment of the present invention.

### DESCRIPTION OF EMBODIMENTS

### First Embodiment

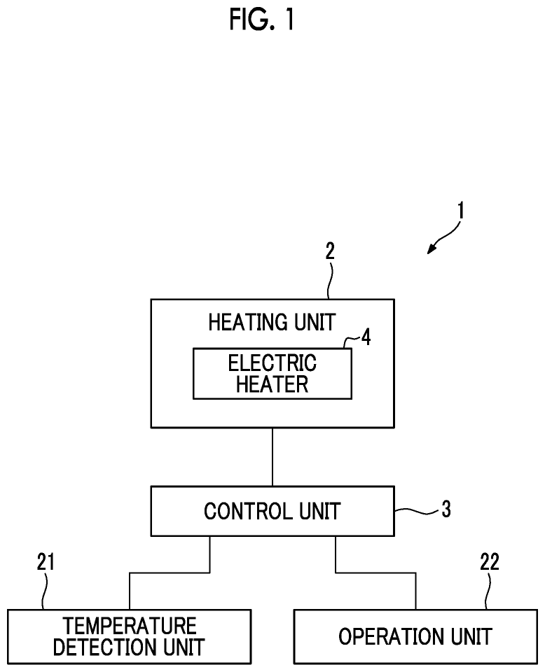

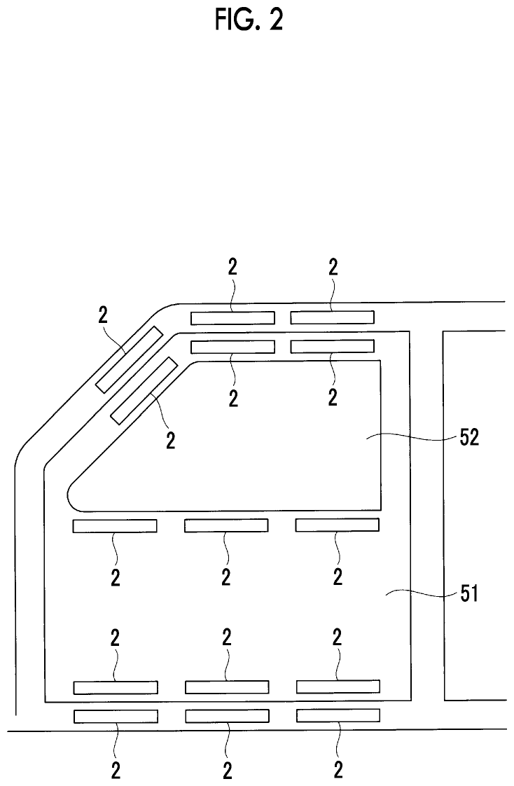

Hereinafter, a heating device 1 for a vehicle according to a first embodiment of the present invention will be described with reference to FIGS. 1 and 2.

The heating device 1 for a vehicle according to the present embodiment is installed in a component of a vehicle provided along an edge of a vehicle opening in an interior of the vehicle, and performs heating to increase the temperature of low-temperature air generated in the vicinity of the vehicle opening. Here, the low-temperature air is air generated along an interior side surface of the vehicle opening by heat transfer from outside air when the outside air has a lower temperature than interior air.

Accordingly, the low-temperature air generated along the interior side surface of the vehicle opening is heated, so that a phenomenon (cold draft) in which air cooled (cold air) through an opening in which a vehicle door 51, a vehicle window 52, or the like illustrated in FIG. 2 is provided flows downward in the interior due to convection can be suppressed. The heating device 1 for a vehicle according to the present embodiment is installed in a vehicle such as an automobile.

As illustrated in FIG. 1, the heating device 1 for a vehicle includes a heating unit 2 and a control unit 3.

The heating unit 2 according to the present embodiment is an electric heater 4, and is installed in a component of the vehicle provided along an edge of a vehicle opening. The electric heater 4 uses electric power as a heat source.

Here, as illustrated in FIG. 2, when the heating unit 2 is installed around the vehicle door 51 (for example, a door for getting in and out or a door for loading), the component of the vehicle is a component surrounding an opening in which the vehicle door 51 is installed, and is, for example, a frame of a door for getting in and out or a door for loading. The heating unit 2 may be installed along an edge portion of the vehicle door 51. In this case, the component of the vehicle is the vehicle door 51, and the heating unit 2 is installed along the edge of the vehicle opening.

In addition, when the heating unit 2 is installed around the vehicle window 52 (for example, a front window (windshield), a side window, a rear window, or the like), the component of the vehicle is a component surrounding an opening in which the vehicle window 52 is installed, and is, for example, a frame of the vehicle window 52 or the vehicle door 51 in which a side window is installed.

The electric heater 4 is installed so as to face the interior of the vehicle, so that air on an interior side of the vehicle facing the electric heater 4 is heated. It is desirable that the electric heater 4 is installed in a long shape along the edge of the vehicle opening. Accordingly, air flowing from a vehicle opening side to the interior side can be evenly heated.

In addition, it is desirable that the electric heater 4 is installed such that a high-temperature portion of which the temperature is increased by heating is not exposed to the interior of the vehicle. Accordingly, an occupant can be prevented from coming into contact with the electric heater 4 and getting burned. For example, the electric heater 4 is installed in a recessed portion from a surface of the component of the vehicle, or a grid-shaped cover or the like is installed on an interior side surface of the electric heater 4.

The electric heater 4 performs heating to increase the temperature of low-temperature air generated along the interior side surface of the vehicle opening by heat transfer from the outside air. In the electric heater 4, the heat amount of the electric heater 4 is set so as to increase the temperature of the low-temperature air, which is generated along the interior side surface of the vehicle opening, for example, by 10° C. to several tens of degrees C.

Incidentally, for example, only one electric heater 4 may be installed or a plurality of electric heaters 4 may be installed for one vehicle opening.

The control unit 3 controls heating of the heating unit 2 based on the temperature detected by a temperature detection unit 21. The control unit 3 includes, for example, a central processing unit (CPU), a random access memory (RAM), a read only memory (ROM), a computer-readable storage medium, and the like. Then, as one example, a series of processes for realizing various functions are stored in the storage medium or the like in the form of a program, and the CPU reads the program into the RAM or the like to execute information processing and arithmetic processing, so that the various functions are realized. Incidentally, a form in which the program is installed in the ROM or another storage medium in advance, a form in which the program is provided in a state where the program is stored in the computer-readable storage medium, a form in which the program is distributed via wired or wireless communication means, and the like may be applied. Examples of the computer-readable storage medium include magnetic disks, magneto-optical disks, CD-ROMs, DVD-ROMs, semiconductor memories and the like.

For example, the temperature detection unit 21 may be a sensor mounted in the vehicle in advance, or may be a sensor newly mounted in the vehicle, together with the heating device 1 for a vehicle. The temperature detection unit 21 is, for example, an infrared (IR) sensor, a solar radiation sensor, or the like. Information regarding the temperature detected by the temperature detection unit 21 is transmitted to the control unit 3.

The control unit 3 controls heating of the heating unit 2, for example, based on the temperature received from the temperature detection unit 21 and a predetermined threshold value (temperature). When the control unit 3 determines that the detected temperature is lower than the predetermined temperature, the control unit 3 performs adjustment to increase the heat amount of the heating unit 2. Here, the predetermined temperature may be a value determined in advance, or may be a value determined according to detected outside air temperature, interior temperature, or the like.

When the control unit 3 determines that heating by the heating unit 2 is unnecessary, such as when the detected temperature is the predetermined temperature or more, the control unit 3 stops heating of the heating unit 2.

Incidentally, in the present embodiment, the case has been described in which the heat amount of the heating unit 2 is controlled by automatic control by the control unit 3; however, the present invention is not limited to this example. Namely, an operation unit 22 related to the heating device 1 for a vehicle may be installed, and an occupant (user) may operate the operation unit 22 to control the heating unit 2. In this case, in the operation unit 22, not only heating may be turned on and off but also the magnitude of the heat amount may be adjusted.

Excessive heating of the vehicle opening can be suppressed by decreasing the heat amount of the heating unit 2 on a side exposed to solar radiation in the vehicle. Accordingly, an improvement in the feeling of heating or a reduction in electric power consumption can be achieved.

As described above, according to the present embodiment, the electric heater 4 is installed in the component of the vehicle provided along the edge of the vehicle opening, and low-temperature air generated along an interior side surface of an opening such as a vehicle window is heated by heating of the heating unit 2. As a result, a decrease in temperature of air cooled (cold air) through the opening such as the vehicle window can be reduced, and the phenomenon (cold draft) in which the cold air flows downward in the interior due to convection can be suppressed. In addition, a problem that the feeling of heating to be provided to an occupant is reduced due to cold air is unlikely to occur, and the heating load can be reduced to improve the electric power consumption. The present embodiment is effective in any case of an automobile using an engine (internal combustion engine) as a driving source, an electric vehicle, or a hybrid vehicle in which electric power that can be generated and used in the vehicle or electric power to be stored is limited.

### Second Embodiment

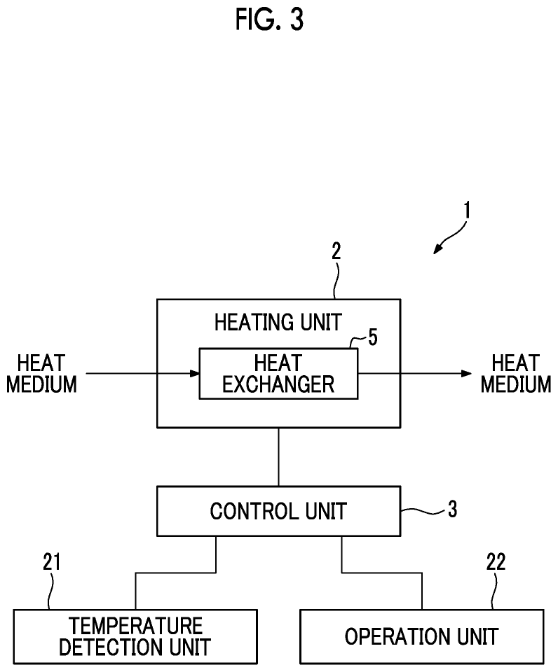

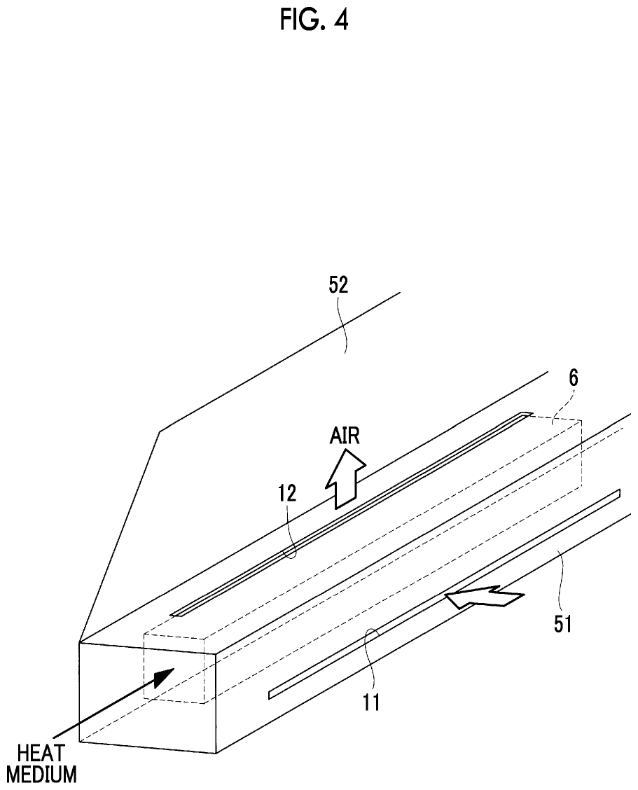

Next, the heating device 1 for a vehicle according to a second embodiment of the present invention will be described with reference to FIGS. 3 and 4. Incidentally, the description of configurations and effects duplicated from the above-described embodiment will be omitted.

The case has been described in which in the heating device 1 for a vehicle according to the first embodiment described above, the heating unit 2 is the electric heater 4; however, as illustrated in FIG. 3, the heating unit 2 according to the present embodiment is a heat exchanger 5 through which a heat medium flows.

The heat medium is, for example, a refrigerant flowing through a heat pump system including a refrigerant circuit, air or water heated by residual heat of an electric heater or an engine, or the like.

When the refrigerant of the heat pump system is used as the heat medium, the refrigerant of which the temperature is increased in an evaporator or which is pressurized by a compressor is supplied to the heat exchanger 5. When air or water heated by residual heat of the electric heater or the engine is used as the heat medium, the air or water heated by the residual heat of the electric heater or the engine is supplied to the heat exchanger 5.

In the heat exchanger 5, the heat medium in a high temperature state exchanges heat with interior air of the vehicle, so that the heat medium is cooled and the interior air is heated. As a result, the heat exchanger 5 performs heating to increase the temperature of low-temperature air generated along an interior side surface of a vehicle opening by heat transfer from outside air. In the heat exchanger 5, the heat amount of the heat exchanger 5 is set so as to increase the temperature of the low-temperature air, which is generated along the interior side surface of the vehicle opening, for example, by 10° C. to several tens of degrees C.

Incidentally, for example, one heat exchanger 5 may be configured or a plurality of heat exchangers 5 may be installed for one vehicle opening.

As illustrated in FIG. 4, the heat exchanger 5 is installed so as to face the interior of the vehicle, so that air on the interior side of the vehicle facing the heat exchanger 5 is heated. It is desirable that the heat exchanger 5 is installed in a long shape along an edge of the vehicle opening. In addition, similar to the heater according to the first embodiment, it is desirable that the heat exchanger 5 is installed such that a high-temperature portion of which the temperature is increased by heating is not exposed to the interior of the vehicle.

The heat exchanger 5 is, for example, a panel member which is a long member. In this case, an air flow path through which air can flow in a direction perpendicular to a length direction is formed. Accordingly, the interior air is heated by convection by natural circulation or radiation from a surface of the heat exchanger 5. The vehicle door 51 may be provided with an intake port 11 and a discharge port 12. Air may be taken in from the intake port 11 and the air heated in the heat exchanger 5 may be discharged from the discharge port 12.

Incidentally, also in the heating device 1 for a vehicle according to the present embodiment, for example, the control unit 3 may control heating of the heating unit based on a temperature received from the temperature detection unit 21 and the predetermined threshold value (temperature), or may control heating of the heating unit 2 through operation of the operation unit 22.

As described above, according to the present embodiment, the heat exchanger 5 is installed in a component of the vehicle provided along the edge of the vehicle opening, and low-temperature air generated along an interior side surface of an opening such as a vehicle window is heated by heating of the heating unit 2. As a result, a decrease in temperature of air cooled (cold air) through the opening such as the vehicle window can be reduced, and the phenomenon (cold draft) in which the cold air flows downward in the interior due to convection can be suppressed. In addition, a problem that the feeling of heating to be provided to an occupant is reduced due to cold air is unlikely to occur, and the heating load can be reduced to improve the electric power consumption.

### Third Embodiment

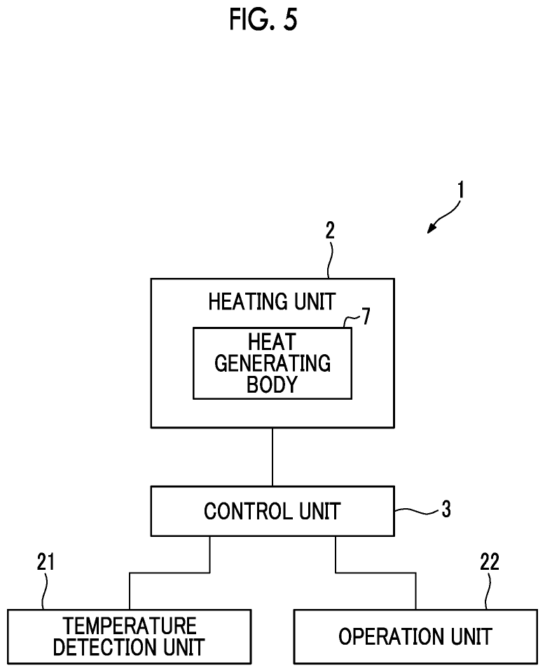

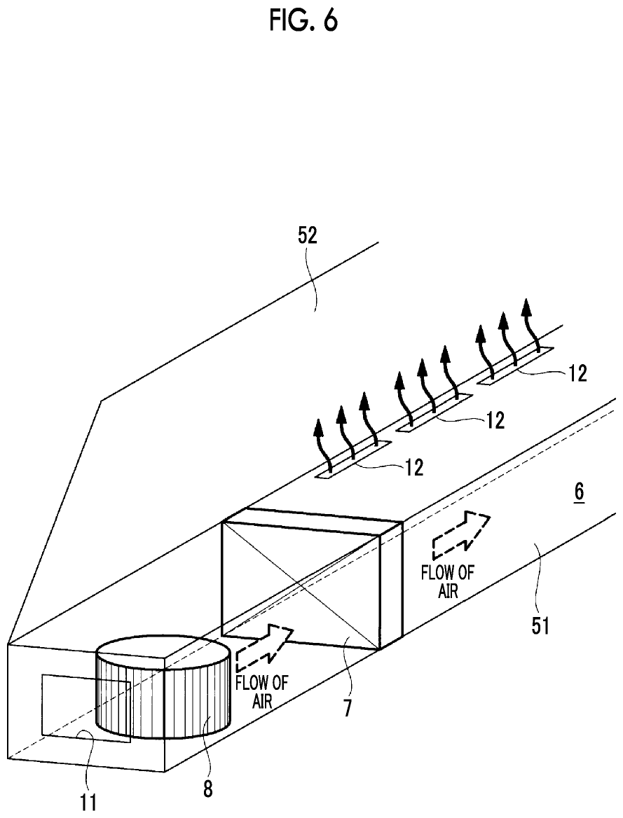

Next, the heating device 1 for a vehicle according to a third embodiment of the present invention will be described with reference to FIGS. 5 and 6. Incidentally, the description of configurations and effects duplicated from the above-described embodiments will be omitted.

The case has been described in which in the heating devices 1 for vehicles according to the first and second embodiments, the electric heater 4 and the heat exchanger 5 are installed so as to face the interior of the vehicle; however, the present invention is not limited to this example.

In the heating unit 2 according to the present embodiment, an electric heater or a heat exchanger itself is not installed so as to face the interior of the vehicle, but a heat generating body 7 such as an electric heater or a heat exchanger is installed in an air flow path (duct) 6, the heat generating body 7 is configured to be capable of heating inflowing air, and the heated air is sent to the interior side.

As illustrated in FIGS. 5 and 6, the heating unit 2 includes the air flow path 6, the heat generating body 7, a blower (blowing unit) 8, and the like. The heating unit is installed in a component of the vehicle provided along an edge of a vehicle opening.

The air flow path 6 is formed such that air can flow from the intake port 11 on one end side to the discharge port 12 on the other end side. Air taken in from the intake port 11 is interior air, and is different from air to be directly supplied from HVAC. The interior air taken from the intake port 11 flows toward the other end side, and is sent from the discharge port 12 to the interior side through the heat generating body 7.

The heat generating body 7 is an electric heater or a heat exchanger, and is installed in the middle of the air flow path 6 or in the vicinity of the intake port 11 or the discharge port 12. The heat generating body 7 heats the air flowing through the air flow path 6. As a result, the air heated by the heat generating body 7 is sent from the discharge port 12 to the interior side. The heat generating body 7 performs heating to increase the temperature of low-temperature air generated along an interior side surface of the vehicle opening by heat transfer from outside air. In the heat generating body 7, the heat amount of the heat generating body 7 is set so as to increase the temperature of the low-temperature air, which is generated along the interior side surface of the vehicle opening, for example, by 10° C. to several tens of degrees C.

An electric heater as the heat generating body 7 uses electric power as a heat source. In addition, when a heat exchanger through which a heat medium flows is used as the heat generating body 7, for example, the heat medium is a refrigerant flowing through a heat pump system including a refrigerant circuit, air or water heated by residual heat of an electric heater or an engine, or the like.

The discharge port 12 is installed so as to face the interior of the vehicle. It is desirable that the discharge port 12 is installed in a long shape along the edge of the vehicle opening. For example, one discharge port 12 may be configured or a plurality of discharge ports 12 may be installed for one vehicle opening.

The blower 8 sends air from the one end side to the other end side of the air flow path 6. The blower 8 is installed separately from a blower of HVAC installed in the vehicle. The amount of air to be sent by the blower 8 may be the amount of air which is discharged from the discharge port 12 to be capable of reaching the interior side surface of the vehicle opening and heating a cold air layer, and unlike HVAC, does not have to be the amount of air circulating in the interior.

Incidentally, also in the heating device 1 for a vehicle according to the present embodiment, for example, the control unit 3 may control heating of the heating unit based on a temperature received from the temperature detection unit 21 and the predetermined threshold value (temperature), or may control heating of the heating unit 2 through operation of the operation unit 22.

As described above, according to the present embodiment, the heating unit 2 is installed in a component of the vehicle provided along the edge of the vehicle opening, and low-temperature air generated along an interior side surface of an opening such as a vehicle window is heated by heating of the heating unit 2. As a result, a decrease in temperature of air cooled (cold air) through the opening such as the vehicle window can be reduced, and the phenomenon (cold draft) in which the cold air flows downward in the interior due to convection can be suppressed. In addition, a problem that the feeling of heating to be provided to an occupant is reduced due to cold air is unlikely to occur, and the heating load can be reduced to improve the electric power consumption.

### REFERENCE SIGNS LIST

1: Heating device for vehicle

2: Heating unit

3: Control unit

4: Electric heater

5: Heat exchanger

6: Air flow path

7: Heat generating body

8: Blower (blowing unit)

21: Temperature detection unit

22: Operation unit

51: Vehicle door

52: Vehicle window

1. A heating device for a vehicle comprising:
a heating unit that is installed in a component of a vehicle provided along an edge of a vehicle opening and above or below a door, the door being installed in the vehicle opening, and that performs heating to increase a temperature of low-temperature air generated along an interior side surface of the vehicle opening by heat transfer from outside air.

2. A heating device for a vehicle comprising:
a heating unit that is installed in a component of a vehicle provided along an edge of a vehicle opening and above or below a vehicle window, the vehicle window being installed in the vehicle opening, and that performs heating to increase a temperature of low-temperature air generated along an interior side surface of the vehicle opening by heat transfer from outside air.

3. The heating device for a vehicle according to claim 1,
wherein the heating unit includes an electric heater using electric power as a heat source.

4. The heating device for a vehicle according to claim 1,
wherein the heating unit includes a heat exchanger through which a heat medium of which a temperature is increased by heating flows.

5. The heating device for a vehicle according to claim 1,
wherein the heating unit is installed so as to face an interior of the vehicle.

6. The heating device for a vehicle according to claim 5,
wherein the heating unit is installed such that a high-temperature portion of which a temperature is increased by heating is not exposed to the interior of the vehicle.

7. The heating device for a vehicle according to claim 1,
wherein an air flow path in which the heating unit is installed and through which air flows, and a blowing unit which causes the air to flow through the air flow path are provided, and
the heating unit is configured to heat the air flowing through the air flow path.

8. The heating device for a vehicle according to claim 1, further comprising:
a control unit that controls heating of the heating unit based on a temperature detected by a temperature detection unit that is installed in the component of the vehicle to detect the temperature.

9. A vehicle comprising:
the heating device for a vehicle according to claim 1.

10. The heating device for a vehicle according to claim 2,
wherein the heating unit includes an electric heater using electric power as a heat source.

11. The heating device for a vehicle according to claim 2,
wherein the heating unit includes a heat exchanger through which a heat medium of which a temperature is increased by heating flows.

12. The heating device for a vehicle according to claim 2,
wherein the heating unit is installed so as to face an interior of the vehicle.

13. The heating device for a vehicle according to claim 3,
wherein the heating unit is installed so as to face an interior of the vehicle.

14. The heating device for a vehicle according to claim 4,
wherein the heating unit is installed so as to face an interior of the vehicle.

15. The heating device for a vehicle according to claim 2,
wherein an air flow path in which the heating unit is installed and through which air flows, and a blowing unit which causes the air to flow through the air flow path are provided, and
the heating unit is configured to heat the air flowing through the air flow path.

16. The heating device for a vehicle according to claim 3,
wherein an air flow path in which the heating unit is installed and through which air flows, and a blowing unit which causes the air to flow through the air flow path are provided, and
the heating unit is configured to heat the air flowing through the air flow path.

17. The heating device for a vehicle according to claim 4,
wherein an air flow path in which the heating unit is installed and through which air flows, and a blowing unit which causes the air to flow through the air flow path are provided, and
the heating unit is configured to heat the air flowing through the air flow path.

18. The heating device for a vehicle according to claim 2, further comprising:
a control unit that controls heating of the heating unit based on a temperature detected by a temperature detection unit that is installed in the component of the vehicle to detect the temperature.

19. The heating device for a vehicle according to claim 3, further comprising:
a control unit that controls heating of the heating unit based on a temperature detected by a temperature detection unit that is installed in the component of the vehicle to detect the temperature.

20. The heating device for a vehicle according to claim 4, further comprising:
a control unit that controls heating of the heating unit based on a temperature detected by a temperature detection unit that is installed in the component of the vehicle to detect the temperature.
